(19) United States
(12) Patent Application Publication
(10) Pub. No.: US 2009/0007730 A1
(43) Pub. Date: Jan. 8, 2009

(54) Apparatus for removing earrings from a purchase card

(76) Inventor: Alexa Lea Haushalter, Bellefontaine, OH (US)

Correspondence Address: Barbara Joan Haushalter;Law Office, 228 Bent Pines Court, Bellefontaine, OH, 43311, US

(21) Appl. No.: 11/825,083

(22) Filed: Jul. 3, 2007

(51) Int. Cl. B67B 7/00; B25C 11/00

(52) U.S. Cl. 81/3.32; 227/63; 81/3.31; 81/3.36; 81/3.55

(57) ABSTRACT

An apparatus for removing earrings from a display card includes a pronged mechanism for slipping between the ornamental portion of the earring and the card. A user applies leverage to the pronged mechanism to separate the earring from the card. The pronged mechanism can be enhanced with a cover for preventing the earring from flipping away as it is removed from the card. The cover can be attached to the pronged portion by any suitable means, such as a band, adhesive, hinge, or other means. When the pronged mechanism removes the earring from the card, the earring retainer on the back of the earring necessarily also separates from the card, so the device can be further enhanced with a cup means for catching and containing the earring retainer. The apparatus can be a single, integrated device.

### BACKGROUND OF THE INVENTION

The present invention relates to an earring removal apparatus and, more particularly, to a tool for removing earrings from the display cards that earrings are typically attached to when a customer purchases new earrings.

Throughout the years of recorded history, men and women have been eager to possess and use ornamental jewelry about their clothing and person. Earrings in particular have been used by both sexes, and still are for reasons that are both varied and ornamental. As a result of the attractiveness of the use of earrings, many people, particularly women, make fairly frequent purchases of earrings for the pleasure of variety.

Earrings for pierced ears are, perhaps, the more popular form of earrings worn currently, typically by women, but also by men. Such earrings include an exposed ornamental design which may include a precious stone or metal, and a post or thin elongated shaft extending therefrom. The post is inserted through a previously pierced hole in the ear lobe and, thereafter, held in position in the ear by a retainer which is slid onto the post behind the ear lobe. Most individuals who wear jewelry of this type gradually acquire a collection of different styles and designs of pierced earrings. Sometimes, the purchaser will remove the earrings from the display card as soon as the earrings are purchased, but earrings purchased for a special occasion may be saved on the purchase card until the occasion to wear them arises.

Typically, the purchaser uses their fingers, particularly their fingernails, to grasp the front and back of the earring, and remove same from the purchase card. If earrings have been saved on the display card until the special occasion for wearing the earrings arrives, the purchaser may be completely primped and ready, save for the removal of the earrings from the card. Unfortunately, this activity often nicks or damages ones fingernails. Although a nicked fingernail can be filed back to shape, if the purchaser has a manicure, the damage to the manicure is not easily repaired.

Manicures are part of our popular culture. In fact, one quarter of all American women have regular professional manicures, and even 4 percent of men say they have regular professional manicures. And fully half of American women give manicures to themselves. From a worldwide survey of fourteen hundred people by TripAdvisor asking for their opinions on flying, manicures was one of the top five luxuries travelers would pay extra for. Considering that some salons charge upwards of $75 for a full manicure, this is an investment most people want to protect.

It would be desirable, then, to have a means for removing earrings from a display card which avoids nicking and scratching of ones fingernails and manicure. It would be particularly desirable to be able to detach earrings from a display card while protecting ones manicure.

### SUMMARY OF THE INVENTION

This need is met by the earring extractor apparatus according to the present invention, wherein the apparatus is particularly suitable for detaching earrings from a purchase card without damaging ones manicure. It is an advantage of the present invention that nicking and scratching of ones fingernails and manicure, while detaching earrings from a display card, is prevented.

In accordance with one aspect of the present invention, an apparatus for removing earrings from a display card comprises a pronged mechanism for slipping between the earring and the card. The pronged mechanism preferably has an associated handle for the user to hold as he or she slides the pronged mechanism between the earring and the card. The pronged mechanism can be enhanced with a cover for preventing the earring from flipping away as it is removed from the card. The cover can be attached to the pronged portion by any suitable means, such as a band, adhesive, or other means.

The earring comprises a front, ornamental portion, with a post extending therefrom. A retainer is insertable on the post to retain the earring on the purchase card, and later to retain the earring on the ear of the wearer. When the pronged mechanism removes the earring from the card, the earring retainer also necessarily separates from the card, so the device can be further enhanced with a cup means for catching and containing the earring retainer. Finally, in one embodiment of the present invention, the pronged mechanism, handle, cover and cover attachment means, and cup means can all be connected with a connector means, whereby the device becomes a single, integrated tool. The connector means preferably comprises means for securing the handle, which is attached to the pronged portion and cover, to the cup. Hence, the cup can be associated with an extension means approximately the length of the handle, so the handle and the extension means reach the connector means, resulting in an integrated device.

Accordingly, it is an object of the present invention to provide an earring extractor for removing earrings from a display card without incurring damage to ones fingernails or manicure. The earring extractor is particularly suited for use with pierced earrings. Other objects and advantages of the invention will be apparent from the following description, the accompanying drawings and the appended claims.

### BRIEF DESCRIPTION OF THE DRAWINGS

FIG. 1 is an exploded view of the earring extractor in accordance with the present invention;

FIG. 2 is a view of the apparatus of the present invention being used for its intended purpose of removing earrings from an earring display card; and

FIG. 3 is a side view of a preferred embodiment of the present invention.

### DETAILED DESCRIPTION OF THE PREFERRED EMBODIMENTS

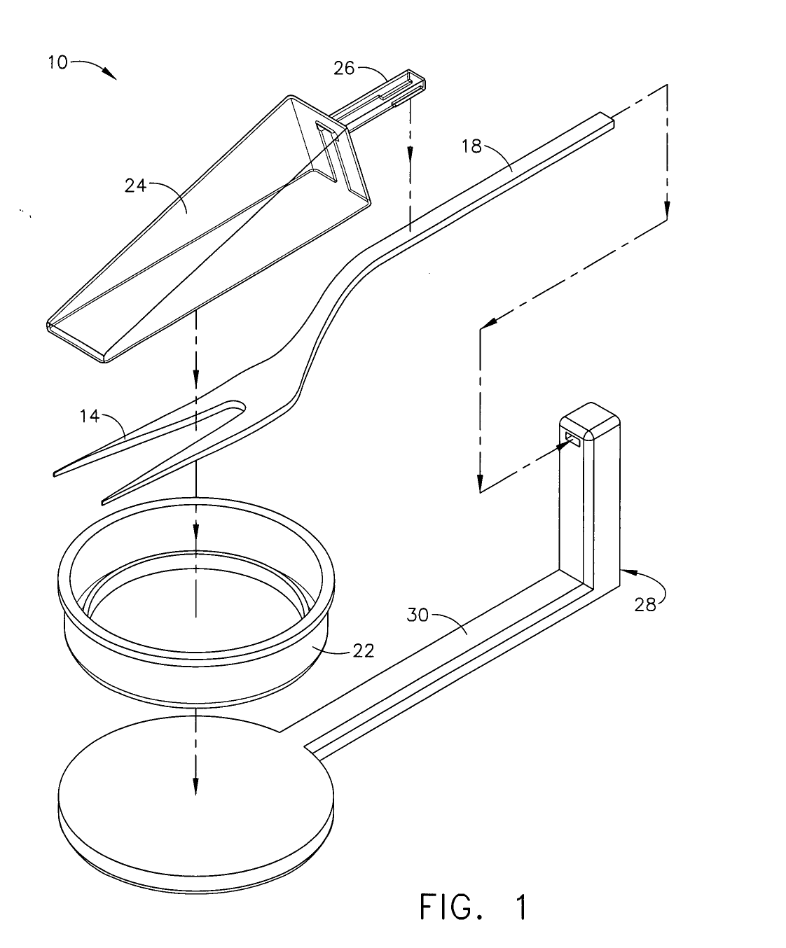

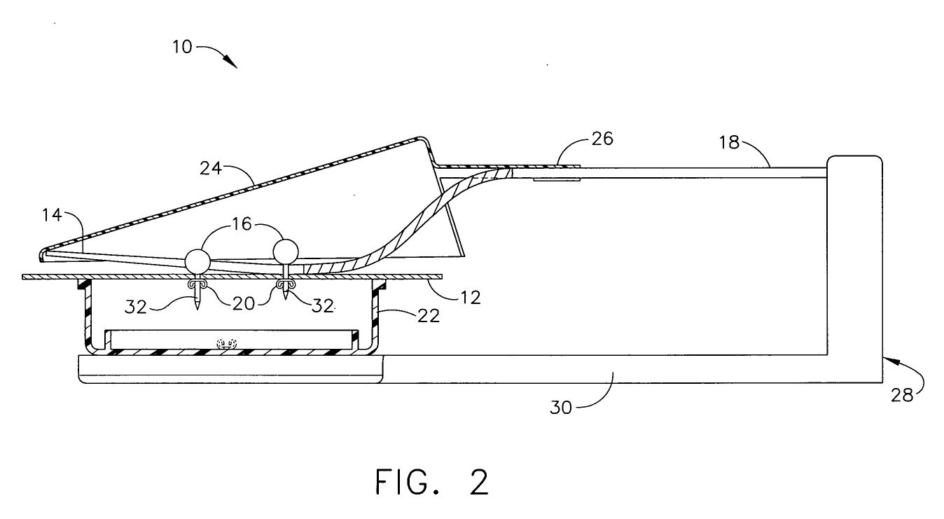

Referring to the drawings, in FIG. 1, there is illustrated an earring extractor apparatus 10 according to the present invention. The apparatus illustrated in FIG. 1 is particularly adaptable for removing pierced earrings from a display or purchase card 12, as illustrated in FIG. 2. The present invention is illustrated for use on earrings having an ornamental portion 16 with a post 32 extending therefrom, and an earring retainer 20 insertable on the post 32 to hold the earring to the card 12 or to an ear. The card 12 is situated between the ornamental portion 16 and the earring retainer 20. Besides offering an easy means for detaching earrings from a purchase card, the apparatus 10 is useful in that the removal of the earring from the card can be accomplished without nicking ones fingernails, or otherwise damaging ones manicure.

Continuing with FIGS. 1 and 2, the apparatus 10 comprises a pronged mechanism 14 for slipping between the ornamental portion 16 of the earring and the card 12. The pronged mechanism 14 preferably has an associated handle 18 for the user to hold as he or she slides the pronged mechanism 14 between the earring ornament 16 and the card 12. Once the pronged mechanism is correctly located with reference to the earring and the display card, leverage can be applied upward to remove the ornamental portion 16 of the earring from the card 12. As the earring separates from the card, the earring retainer 20, insertable on the post 32 extending from the ornamental portion 16 of the earring, also separates from the card 12, on the back side of the card. Hence, in a preferred embodiment of the present invention, the apparatus 10 further comprises a cup means 22 for catching and containing the earring retainer 20.

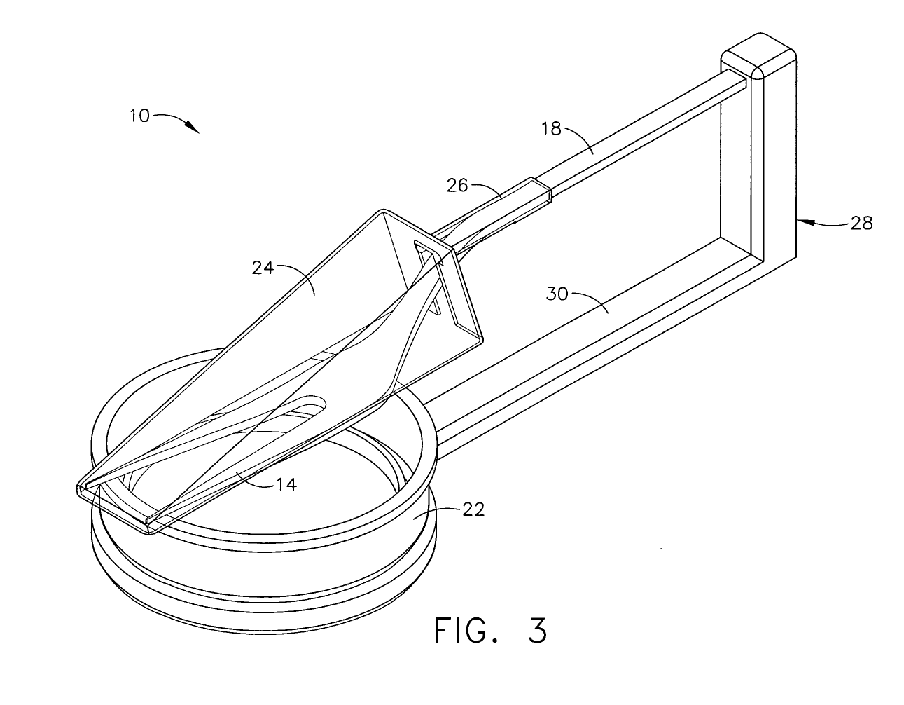

Referring now to FIG. 3, and continuing with FIGS. 1 and 2, the pronged mechanism 14 can further be enhanced with a cover 24 for preventing the ornamental portion 16 of the earring from flipping away when sufficient leverage is applied to remove it from the card. The cover 24 can be attached to the pronged portion 14 by any suitable means 26, such as a band, an adhesive, a hinge, or any other like means. Furthermore, in one embodiment of the present invention, the pronged mechanism 14, handle 18, cover 24 and cover attachment means 26, and cup means 22 can all be connected with a connector means 28, whereby the device 10 becomes a single, integrated tool. The connector means 28 associates the handle 18, which is attached to the pronged portion 14 and cover 24, to the cup 22. Hence, the cup 22 can be associated with an extension means 30 approximately the length of the handle 18, so that the handle and extension means meet at the common region of the connector means 28, resulting in an integrated device.

Having described the invention in detail and by reference to the preferred embodiment thereof, it will be apparent that other modifications and variations are possible without departing from the scope of the invention defined in the appended claims.

What is claimed is:

1. An apparatus for removing earrings from a purchase display card, the earrings including an ornamental portion with a post extending therefrom, and an earring retainer insertable on the post to hold the earring to the card, the card being situated between the ornamental portion and the earring retainer, the apparatus comprising:
a pronged mechanism for sliding between the earring and the card; and
an associated handle for a user to apply leverage to the pronged mechanism so as to separate the earring from the card.

2. An apparatus as claimed in claim 1 further comprising a cover in association with the pronged mechanism for preventing the ornamental portion of the earring from flipping away as it is removed from the card.

3. An apparatus as claimed in claim 2 wherein the cover further comprises cover attachment means for attaching the cover to the pronged portion.

4. An apparatus as claimed in claim 3 wherein the cover attachment means comprises a rubber band.

5. An apparatus as claimed in claim 3 wherein the cover attachment means comprises adhesive.

6. An apparatus as claimed in claim 3 wherein the cover attachment means comprises a hinged means.

7. An apparatus as claimed in claim 3 further comprising a cup means for catching and containing the earring retainer.

8. An apparatus as claimed in claim 7 further comprising a connector means for connecting the pronged mechanism, the associated handle, the cover, the cover attachment means, and the cup means into an integrated unit.

9. An apparatus as claimed in claim 8 further comprising an extension means extending from the cup means outward toward the connector means to associate the cup means with the connector means.

10. An apparatus for protecting fingernails and manicures when removing earrings from a purchase display card, the earrings including an ornamental portion with a post extending therefrom, and an earring retainer insertable on the post to hold the earring to the card, the card being situated between the ornamental portion and the earring retainer, the apparatus comprising:
a pronged mechanism for sliding between the earring and the card;
a handle associated with the pronged mechanism for a user to apply leverage to the pronged mechanism so as to separate the earring from the card without engaging the fingernails; and
a cover in association with the pronged mechanism for preventing the ornamental portion of the earring from flipping away as leverage is applied to the pronged mechanism and the earring is removed from the card.

11. An apparatus as claimed in claim 10 wherein the cover further comprises cover attachment means for attaching the cover to the pronged portion.

12. An apparatus as claimed in claim 11 wherein the cover attachment means comprises a rubber band.

13. An apparatus as claimed in claim 11 wherein the cover attachment means comprises adhesive.

14. An apparatus as claimed in claim 11 wherein the cover attachment means comprises a hinged means.

15. An apparatus as claimed in claim 10 further comprising a cup means for catching and containing the earring retainer.

16. An apparatus as claimed in claim 15 further comprising a connector means for connecting the pronged mechanism, the associated handle, the cover, and the cup means into an integrated unit.

17. An apparatus for removing earrings from a purchase display card while protecting ones fingernails and manicure, the earrings including an ornamental portion with a post extending therefrom, and an earring retainer insertable on the post to hold the earring to the card, the card being situated between the ornamental portion and the earring retainer, the apparatus comprising:
a pronged mechanism for sliding between the earring and the card;
an associated handle for a user to apply leverage to the pronged mechanism so as to separate the earring from the card; and
a cup means for catching and containing the earring retainer when the earring is removed from the card.

18. An apparatus as claimed in claim 17 further comprising a cover in association with the pronged mechanism for preventing the ornamental portion of the earring from flipping away as it is removed from the card.

19. An apparatus as claimed in claim 18 wherein the cover further comprises cover attachment means for attaching the cover to the pronged portion.

20. An apparatus as claimed in claim 19 further comprising a connector means for connecting the pronged mechanism, the associated handle, the cover, the cover attachment means, and the cup means into an integrated unit.
